(19) United States
(12) Patent Application Publication
(10) Pub. No.: US 2010/0241439 A1
(43) Pub. Date: Sep. 23, 2010

(54) METHOD, MODULE AND COMPUTER SOFTWARE WITH QUANTIFICATION BASED ON GERZON VECTORS

(75) Inventors: Adil Mouhssine, Rennes (FR); Abdellatif Benjelloun Touimi, Londres (GB)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/681,104

(22) PCT Filed: Sep. 30, 2008
(86) PCT No.: PCT/FR08/51764

§ 371 Date: Apr. 23, 2010

(30) Foreign Application Priority Data
Oct. 1, 2007 (FR) 0757972

(51) Int. Cl. G10L 19/00

(52) U.S. Cl. 704/500; 704/E19.001

(57) ABSTRACT

The invention relates to a method for encoding the components (X_{i,k}) of an audio scene including N signals (Si, . . . , SN) with N>1, that comprises the step of quantifying at least some of said components, wherein the quantification is defined based on at least an energy vector and/or one velocity vector associated with Gerzon criteria and based on said components.

The present invention relates to audio signal encoding devices comprising quantification modules and intended in particular to be used in applications for the transmission or storage of digitized and compressed audio signals.

The invention relates more particularly to the encoding of 3D sound scenes. A 3D sound scene, also called spatialized sound, comprises a plurality of audio channels each corresponding to monophonic signals.

In techniques for encoding signals of a sound scene, each monophonic signal is encoded independently of the other signals on the basis of perceptual criteria aimed at reducing the data rate whilst minimizing the perceptual distortion of the encoded monophonic signal in comparison with the original monophonic signal. The audio encoders of the prior art of the MPEG 2/4 AAC type provide techniques for reducing the data rate which minimize the perceptual distortion of the signal.

Another technique for encoding signals of a sound scene, used in the encoder “MPEG Audio Surround” (cf. “Text of ISO/IEC FDIS 23003-1 , MPEG Surround”, ISO/IEC JTC1/SC29ANG11 N8324, July 2006, Klagenfurt, Austria), comprises the extraction and encoding of spatial parameters from all of the monophonic audio signals on the different channels. These signals are then mixed in order to obtain a monophonic or stereophonic signal, which is then compressed by a conventional mono or stereo encoder (for example of the MPEG-4 AAC, HE-AAC, etc. type). At the level of the decoder, the synthesis of the restituted 3D sound scene is carried out on the basis of spatial parameters and the decoded mono or stereo signal.

The encoding of multi-channel signals of a sound scene comprises in certain cases the introduction of a transformation (KLT, Ambiophonic, DCT etc.) making it possible to better take into account the interactions which can exist between the different signals of the sound scene to be encoded.

The problem of providing a reduction in the data rate which respects the spatial aspect of the sound scene then arises for these new types of encoders.

The present invention improves this situation by proposing, according to a first aspect, a method of encoding components of an audio scene comprising N signals, with N>1, comprising a step of quantification of at least some of the components. The method is characterized in that the quantification is defined as a function of at least one energy vector and/or of a velocity vector associated with Gerzon criteria and as a function of the components.

A method according to the invention thus proposes a quantification which takes account of the interactions between the signals of a sound scene and which thus makes it possible to reduce the spatial distortion of the sound scene and therefore respect its original aspect. The allocation of bits to the spatial components is carried out considering the spatial precision and the spatial stability of the restituted sound scene.

The audio quality of the decoded overall sound scene is improved for a given encoding data rate.

In one embodiment, the quantification is defined as a function of variations of at least one of said energy and velocity vectors during variations of components. The allocation of bits to the different components is thus carried out as a function of the impact of their respective variations on the spatial precision and/or the spatial stability of the decoded sound scene.

In one embodiment, variations of components corresponding to the minimization, or to the limitation, of variations of at least one of the energy and velocity vectors are determined and quantification error values making it possible to define the quantification of components are derived as a function of said variations of components. This arrangement makes it possible to determine the quantification function which will result in a minimum, or limited, interference of the restituted sound scene.

In one embodiment, a method according to the invention comprises moreover a step of detection of a transition frequency making it possible to determine which one of either the energy vector or the velocity vector to take into account in order to define the quantification of components. Such an arrangement makes it possible to increase the quality of the encoding whilst limiting the amount of calculation to be carried out.

In one embodiment, the components are components obtained by spatial transformation, for example of the ambiophonic type.

In other embodiments, the transformation is a transformation of the time/frequency type, for example a DCT, or also a transformation combination.

In one embodiment the energy vector is calculated as a function of an inverse spatial transformation on said spatial components and/or the velocity vector is calculated as a function of an inverse spatial transformation on said spatial components.

According to a second aspect, the invention proposes a module for processing components coming from an audio scene comprising N signals, with N>1, comprising means for determining elements of definition of a step of quantification of at least some of the components, as a function at least of the energy vector and/or of the velocity vector associated with Gerzon criteria and as a function of components.

According to a third aspect, the invention proposes an audio encoder suitable for encoding components of an audio scene comprising N signals, with N>1, comprising:
a module for processing components according to the second aspect of the invention; and
a quantification module suitable for defining quantification indices associated with components as a function at least of elements determined by the processing module.

According to a fourth aspect, the invention proposes computer software to be installed in a processing module, said software comprising instructions for implementing, during an execution of the software by processing means of said module, the steps of a method according to the first aspect of the invention.

Other features and advantages of the invention will furthermore become apparent on reading the following description. The latter is purely illustrative and must be read with reference to the attached drawings in which:

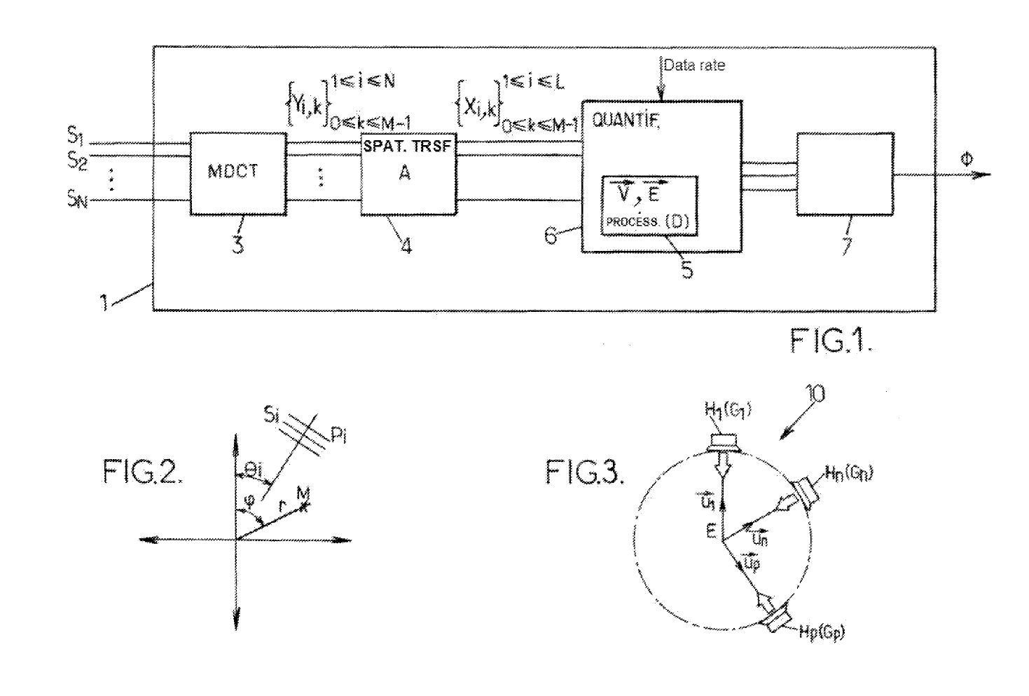

FIG. 1 shows an encoder according to an embodiment of the invention;

FIG. 2 illustrates the propagation of a plane wave in space;

FIG. 3 represents a device for the restitution of a sound scene, comprising loud speakers.

Gerzon criteria are generally used for characterising the localization of the virtual sound sources synthesized during the restitution of signals of a 3D sound scene from the loud speakers of a given sound rendering system.

These criteria are based on the study of the velocity and energy vectors of the acoustic pressures generated by the sound rendering system used.

When a sound rendering system comprises n loud speakers, the n signals generated by these loud speakers, are defined by an acoustic pressure Pi and an angle of acoustic propagation φᵢ, i=1 to n.

The velocity vector \vec{V}, of polar coordinates (r_{V},74 _{V}) is then defined thus:

$$\vec{V} = \{ \begin{matrix}{x}_{V} = \frac{{\sum }_{1 \leq i \leq n} {P}_{i} cos {ϕ}_{i}}{{\sum }_{1 \leq i \leq n} {P}_{i}} = {r}_{V} cos {θ}_{V} \\ {y}_{V} = \frac{{\sum }_{1 \leq i \leq n} {P}_{i} sin {ϕ}_{i}}{{\sum }_{1 \leq i \leq n} {P}_{i}} = {r}_{V} sin {θ}_{V}\end{matrix} \qquad ( 1 )$$

The energy vector \vec{E}, of polar coordinates (r_{E}, θ_{E}) is defined thus:

$$\vec{E} = \{ \begin{matrix}{x}_{E} = \frac{{\sum }_{1 \leq i \leq n} {P}_{i}^{2} cos {ϕ}_{i}}{{\sum }_{1 \leq i \leq n} {P}_{i}^{2}} = {r}_{E} cos {θ}_{E} \\ {y}_{E} = \frac{{\sum }_{1 \leq i \leq n} {P}_{i}^{2} sin {ϕ}_{i}}{{\sum }_{1 \leq i \leq n} {P}_{i}^{2}} = {r}_{E} sin {θ}_{E}\end{matrix} \qquad ( 2 )$$

The conditions necessary for the localization of the virtual sound sources to be optimal are defined by finding the angles φᵢ, characterizing the positions of the loud speakers of the sound rendering system in question, which satisfy the criteria below, called Gerzon criteria, which are the following criteria:

criterion 1, relating to the precision of the sound image of the source S at low frequencies: θ_{V}=θ; where θ is the angle of propagation of the real source S that the system is trying to reproduce.

criterion 2, relating to the stability of the sound image of the source S at low frequencies: r_{y}=1;

criterion 3, relating to the precision of the sound image of the source S at high frequencies: θ_{E}=0;

criterion 4, relating to the stability of the sound image of the source S at high frequencies: r_{E}=1.

The encoder described below in an embodiment of the invention uses the velocity and energy vectors associated with the Gerzon criteria in an application other than that consisting of seeking the best angles φᵢ characterizing the positions of the loud speakers of a sound rendering system in question.

FIG. 1 shows an audio encoder 1 in one embodiment of the invention.

The encoder 1 comprises a time/frequency transformation module 3, a spatial transformation module 4, a quantification module 6 and a module 7 for constituting a binary sequence.

A 3D sound scene to be encoded, considered as an illustration, comprises N channels (with N>1) on each one of which a respective signal Sᵢ, . . . , S_{N} is delivered.

The time/frequency transformation module 3 of the encoder 1 receives on its input the N signals Sᵢ, S_{N} of the 3D sound scene to be encoded.

Each signal Sᵢ, i=1 to N, is represented by the variation of its omnidirectional acoustic pressure Pi and the angle θᵢ of propagation, in the space of the 3D scene, of the associated acoustic wave.

The time/frequency transformation module 3 carries out a time/frequency transformation over each time frame of each one of these signals indicating the different values taken over the course of time by the acoustic pressure Pi. It determines, in the present case, for each of the signals Sᵢ, i=1 to N, its spectral representation characterized by M MDCT coefficients Y_{i,k}, with k=0 to M-1. An MDCT coefficient Y_{i,k} thus represents the element of the spectrum of the signal S, for the frequency Fₖ.

The spectral representations Y_{i,k}, k=0 to M-1, of the signals Sᵢ, i=1 to N, are provided as inputs of the spatial transformation module 4, which also receives as input the angles θᵢ of acoustic propagation characterizing the input signals Sᵢ.

The spatial transformation module 4 is designed to carry out a spatial transformation of the input signals provided, i.e. to determine the spatial components of these signals resulting from the projection onto a spatial reference system depending on the order of the transformation.

The order of a spatial transformation is associated with the angular frequency according to which it “scans” the sound field.

In one embodiment, the spatial transformation in question is ambiophonic transformation. The sound scene is then represented by a set of signals called ambiophonic components, which make it possible to store the sound information relating to the acoustic field. This representation facilitates the manipulation of the acoustic field (rotation of the sound scene, distortion of perspective, i.e. the possibility of compressing the frontal scene and expanding the rear scene) and the extraction of the relevant parameters for reproduction on a given device.

Another advantage of ambiophonic transformation is that, in the case where the number N of signals of the sound scene is large, it is possible to represent them by a number L of ambiophonic components much lower than N, whilst degrading the spatial quality of the sound scene very little. The volume of data to be transmitted is therefore reduced and this happens without significant degradation of the audio quality of the sound scene.

Thus, in the case in question, the spatial transformation module 4 carries out an ambiophonic transformation, which gives a compact spatial representation of a 3D sound scene, by making projections of the sound field on the associated cylindrical or spherical harmonic functions.

For more information on ambiophonic transformations, reference can be made to the following documents: “Représentation de champs acoustiques, application à la transmission et à la reproduction de scènes sonores complexes dans un contexte multimédia (Representation of acoustic fields, application to the transmission and reproduction of complex sound scenes in a multimedia context)”, Doctoral thesis of University of Paris 6, Jerôme DANIEL, 31 Jul. 2001, and “A highly scalable spherical microphone array based on an orthonormal decomposition of the sound field”, Jens Meyer-Gary Elko, Vol. II-pp. 1781-1784 in Proc. ICASSP 2002.

With reference to FIG. 2, the following formula gives the break down into cylindrical harmonics of infinite order of a signal Sᵢ of the sound scene:

$${S}_{i} ( r , ϕ ) == Pi \cdot [ {J}_{0} ( kr ) + {\sum }_{1 \leq m \leq ∞} 2 \cdot {j}^{m} {J}_{m} ( kr ) \cdot ( \begin{matrix}cos m \cdot {θ}_{i} \cdot cos m \cdot ϕ + \\ sin m \cdot {θ}_{i} \cdot sin m \cdot ϕ\end{matrix} ) ]$$

where (Jₘ) represents the Bessel functions, r the distance between the centre of the reference system and the position of a listener placed at a point M, Pi the acoustic pressure of the signal Sᵢ, θᵢ the angle of propagation of the acoustic wave corresponding to the signal Sᵢ and φ the angle between the position of the listener and the axis of the reference system.

If the ambiophonic transformation is of finite order p, for a 2D ambiophonic transformation (according to the horizontal plane), the ambiophonic transform of a signal Sᵢ expressed in the time domain then comprises the following 2p+1 components:

(Pi, Pi.cosθᵢ, Pi.sinθᵢ, Pi.cos2θᵢ, Pi.sin2θᵢ, Pi.cos3θᵢ, Pi.sin3θᵢ, . . . , Pi.cospθᵢ, Pi.sinpθᵢ).

A 2D ambiophonic transformation is considered hereafter. The invention can however be used with a 3D ambiophonic transformation (in such a case, it is considered that the loud speakers are arranged over a sphere).

Moreover, the invention can be used with an ambiophonic transformation of any order p, for example p=2 or more.

Let

$$A = {( {A}_{i , j} )}_{1 \leq i \leq L \\ 1 \leq j \leq N}$$

be the ambiophonic transformation matrix of order p for the 3D scene.

Then

$${A}_{1 , j} = 1 , {A}_{i , j} = \sqrt{2} cos [ ( \frac{i}{2} ) ] {θ}_{j} ,$$

if i is even and

$${A}_{i , j} = \sqrt{2} sin [ ( \frac{i - 1}{2} ) ] {θ}_{j}$$

if i is odd, giving:

$$A = [ \begin{matrix}1 & 1 & … & 1 \\ \sqrt{2} cos {θ}_{1} & \sqrt{2} cos {θ}_{2} & … & \sqrt{2} cos {θ}_{N} \\ \sqrt{2} sin {θ}_{1} & \sqrt{2} sin {θ}_{2} & … & \sqrt{2} sin {θ}_{N} \\ \sqrt{2} cos 2 θ & \sqrt{2} cos 2 {θ}_{2} & … & \sqrt{2} cos 2 {θ}_{N} \\ \sqrt{2} sin 2 {θ}_{1} & \sqrt{2} sin 2 {θ}_{2} & … & \sqrt{2} sin 2 {θ}_{N} \\ & & … & \\ & & … & \\ \sqrt{2} cos p {θ}_{1} & \sqrt{2} cos p {θ}_{2} & … & \sqrt{2} cos p {θ}_{N} \\ \sqrt{2} sin p {θ}_{1} & \sqrt{2} sin p {θ}_{2} & … & \sqrt{2} sin p {θ}_{N}\end{matrix} ] .$$

Let Y be the matrix of the frequency components of the signals Sᵢ, i=1 to N:

$$Y = {( {Y}_{i , k} )}_{1 \leq i \leq N \\ 0 \leq k \leq M - 1} .$$

Let X be the matrix of the ambiophonic components:

$$X = {( {X}_{i , k} )}_{1 \leq i \leq L \\ 0 \leq k \leq M - 1} .$$

The matrix X of the ambiophonic components is determined using the following equation:

X=A.Y (3)

The spatial transformation module 4 is thus designed to determine the matrix X, using the equation (3) according to the data Y_{i,k} and θᵢ, (i=1 to N, k=0 to M-1) which are supplied to it as input.

The values X_{i,k} (i=1 to L, k=0 to M-1), which are the elements to be encoded by the encoder 1 in a binary sequence, are supplied as input to the quantification module 6.

The quantification module 6 comprises a processing module 5 designed to implement a method for defining the quantification function to be applied to received ambiophonic components X_{i,k} (i=1 to L, k=0 to M-1). The method uses relationships between the variations of the velocity and energy vectors used in the Gerzon criteria and the variations of the ambiophonic components.

The quantification function thus defined is then applied to the ambiophonic components received by the quantification module 6.

The steps of definition of the quantification function used by the processing module 5 are based on the principles described below, in relation to the values obtained X_{i,k} (i=1 to L, k=0 to M-1), of the ambiophonic components to be quantified.

Let D be the ambiophonic decoding matrix of order p for a regular audio rendering system with Q′ loud speakers (i.e. the loud speakers are arranged regularly around a point).

$$X [ k ] = ( \begin{matrix}{X}_{1 , k} \\ ⋮ \\ {X}_{L , k}\end{matrix} )$$

is the vector for the frequency Fₖ (k=0 to M-1) of the ambiophonic components of order p with L=2p+1 and

$$T [ k ] = ( \begin{matrix}{T}_{1 , k} \\ ⋮ \\ {T}_{{Q}^{′} , k}\end{matrix} )$$

is the vector of the powers of the respective signals delivered to the Q′ loud speakers after ambiophonic decoding.

We then have T[k]=D.X[k] (4)

If (φ₁, . . . , φ_{Q′}) is the vector of the angles of acoustic propagation from the respective Q′ loud speakers, then the ambiophonic decoding matrix D of order p is written as follows:

$$\begin{matrix}D = {( {d}_{i , j} )}_{1 \leq i \leq {Q}^{′} \\ 1 \leq j \leq L} \\ = [ \begin{matrix}1 & \frac{1}{\sqrt{2}} cos {ϕ}_{1} & \frac{1}{\sqrt{2}} sin {ϕ}_{1} & ⋯ & \frac{1}{\sqrt{2}} cos p {ϕ}_{1} & \frac{1}{\sqrt{2}} sin p {ϕ}_{1} \\ 1 & \frac{1}{\sqrt{2}} cos {ϕ}_{2} & \frac{1}{\sqrt{2}} sin {ϕ}_{2} & ⋯ & \frac{1}{\sqrt{2}} cos p {ϕ}_{2} & \frac{1}{\sqrt{2}} sin p {ϕ}_{2} \\ … & … & … & … & … & … \\ … & … & … & … & … & … \\ 1 & \frac{1}{\sqrt{2}} cos {ϕ}_{{Q}^{′}} & \frac{1}{\sqrt{2}} sin {ϕ}_{{Q}^{′}} & ⋯ & \frac{1}{\sqrt{2}} cos p {ϕ}_{{Q}^{′}} & \frac{1}{\sqrt{2}} sin p {ϕ}_{{Q}^{′}}\end{matrix} ]\end{matrix}$$

It will be noted that a regular system has been chosen because the decoding matrix then has reduced computing complexity (if D′ is the ambiophonic matrix of order p designed to encode L signals, the decoding matrix is then

$${D}_{decoding} = \frac{1}{L} {D}^{′ T} ) .$$

Another ambiophonic decoding matrix can however be used by the processing module 5.

The coordinates of the velocity \vec{V} and energy \vec{E} vectors, that are hereafter referred to as Gerzon vectors, satisfy the following expressions, for the frequency Fₖ, k=0 to M-1:

$$\{ \begin{matrix}{r}_{V} cos {θ}_{V} [ k ] = \frac{{\sum }_{1 \leq i \leq {Q}^{′}} {T}_{i , k} cos {ϕ}_{i}}{{\sum }_{1 \leq i \leq {Q}^{′}} {T}_{i , k}} \\ {r}_{V} sin {θ}_{V} [ k ] = \frac{{\sum }_{1 \leq i \leq {Q}^{′}} {T}_{i , k} sin {ϕ}_{i}}{{\sum }_{1 \leq i \leq {Q}^{′}} {T}_{i , k}} \\ {r}_{E} cos {θ}_{E} [ k ] = \frac{{\sum }_{1 \leq i \leq {Q}^{′}} {T}_{i , k}^{2} cos {ϕ}_{i}}{{\sum }_{1 \leq i \leq {Q}^{′}} {T}_{i , k}^{2}} \\ {r}_{E} sin {θ}_{E} [ k ] = \frac{{\sum }_{1 \leq i \leq {Q}^{′}} {T}_{i , k}^{2} sin {ϕ}_{i}}{{\sum }_{1 \leq i \leq {Q}^{′}} {T}_{i , k}^{2}} ,\end{matrix}$$

and, as a result, the following (equations (5)) are obtained:

$$\{ \begin{matrix}tan {θ}_{V} [ k ] = \frac{{\sum }_{1 \leq i \leq {Q}^{′}} ( {\sum }_{1 \leq j \leq L} {d}_{i , j} \cdot {X}_{j , k} ) sin {ϕ}_{i}}{{\sum }_{1 \leq i \leq {Q}^{′}} ( {\sum }_{1 \leq j \leq L} {d}_{i , j} \cdot {X}_{j , k} ) cos {ϕ}_{i}} \\ tan {θ}_{E} [ k ] = \frac{{\sum }_{1 \leq i \leq {Q}^{′}} {( {\sum }_{1 \leq j \leq L} {d}_{i , j} \cdot {X}_{j , k} )}^{2} sin {ϕ}_{i}}{{\sum }_{1 \leq i \leq {Q}^{′}} {( {\sum }_{1 \leq j \leq L} {d}_{i , j} \cdot {X}_{j , k} )}^{2} cos {ϕ}_{i}} \\ {r}_{V}^{2} = \frac{\begin{matrix}{( {\sum }_{1 \leq i \leq {Q}^{′}} ( {\sum }_{1 \leq j \leq L} {d}_{i , j} \cdot {X}_{j , k} ) sin {ϕ}_{i} )}^{2} + \\ {( {\sum }_{1 \leq i \leq {Q}^{′}} ( {\sum }_{1 \leq j \leq L} {d}_{i , j} \cdot {X}_{j , k} ) cos {ϕ}_{i} )}^{2}\end{matrix}}{{( {\sum }_{1 \leq i \leq {Q}^{′}} ( {\sum }_{1 \leq j \leq L} {d}_{i , j} \cdot {X}_{j , k} ) )}^{2}} \\ {r}_{E}^{2} = \frac{\begin{matrix}{( {\sum }_{1 \leq i \leq {Q}^{′}} {( {\sum }_{1 \leq j \leq L} {d}_{i , j} \cdot {X}_{j , k} )}^{2} sin {ϕ}_{i} )}^{2} + \\ {( {\sum }_{1 \leq i \leq {Q}^{′}} {( {\sum }_{1 \leq j \leq L} {d}_{i , j} \cdot {X}_{j , k} )}^{2} cos {ϕ}_{i} )}^{2}\end{matrix}}{{( {\sum }_{1 \leq i \leq {Q}^{′}} {( {\sum }_{1 \leq j \leq L} {d}_{i , j} \cdot {X}_{j , k} )}^{2} )}^{2}}\end{matrix}$$

This latter system of equations (5) defines the relationship which exists between the ambiophonic components and the Gerzon vectors \vec{V} and \vec{E} defined by their respective polar coordinates (r_{V}, θ_{V}) and (r_{E}, θ_{E}).

A variation of the values taken by the ambiophonic components therefore implies a corresponding variation or displacement of the Gerzon vectors about their original position.

Now, in the case where the ambiophonic components are quantified, their quantified values are nothing other than values close to their true values. The effect on the Gerzon vectors of an elementary displacement h about values of ambiophonic components will now be determined.

By definition of the differential of a compound function, it can be written that:

$$\{ \begin{matrix}d tan ( {θ}_{V} [ k ] ( h ) ) = ( 1 + {tan}^{2} ( {θ}_{V} [ k ] ( h ) ) ) \cdot d {θ}_{V} [ k ] ( h ) \\ d tan ( {θ}_{E} [ k ] ( h ) ) = ( 1 + {tan}^{2} ( {θ}_{E} [ k ] ( h ) ) ) \cdot d {θ}_{E} [ k ] ( h ) \\ {dr}_{V}^{2} ( h ) = 2 {r}_{V} ( h ) \cdot {dr}_{V} \\ {dr}_{E}^{2} ( h ) = 2 {r}_{E} ( h ) \cdot {dr}_{E}\end{matrix} \qquad ( 6 )$$

It can be derived from of these equations (6) that knowledge of the variations of the functions tan(θ_{V}[k]), tan(θ_{E}[k]), r_{V}² and r_{E}^{e} makes it possible to determine the corresponding variation of the Gerzon vectors about the vector h.

The vector

$$h = ( \begin{matrix}{h}_{1} \\ ⋮ \\ {h}_{L}\end{matrix} )$$

represents the quantification error for a frequency Fₖ of the ambiophonic components X_{i,k} (i=1 to L) in question.

The differential of the function tan(θ_{E})[k] about the vector h can be written as follows:

$$d tan ( {θ}_{V} [ k ] ( h ) ) = {\sum }_{n = 1}^{L} {h}_{n} \cdot \frac{\partial tan ( {θ}_{V} [ k ] )}{\partial {X}_{n}} \qquad ( 7 )$$

By then calculating, using the equations (5), the partial derivatives of the functions tan(θ_{E})[k] and r_{V}² with respect to the variation (hₙ)_{1≦n≦L} of each ambiophonic component (Xₙ)_{1≦n≦L}, we obtain for n ε[1, L], k ε[0, M-1], (equations (8)):

$$\frac{\partial tan ( {θ}_{V} [ k ] )}{\partial {X}_{n}} = \frac{{\sum }_{r = 1}^{{Q}^{′}} {\sum }_{i = 1}^{{Q}^{′}} {d}_{r , n} ( {\sum }_{j = 1}^{L} {d}_{i , j} \cdot {X}_{j , k} ) sin ( {ϕ}_{r} - {ϕ}_{i} )}{{( {\sum }_{i = 1}^{{Q}^{′}} ( {\sum }_{j = 1}^{L} {d}_{i , j} \cdot {X}_{j , k} ) cos {ϕ}_{i} )}^{2}} , \\ \frac{\partial {r}_{V}^{2}}{\partial {X}_{n}} = 2 \frac{\begin{matrix}{\sum }_{r = 1}^{{Q}^{′}} {\sum }_{i = 1}^{{Q}^{′}} {\sum }_{j = 1}^{L} {d}_{r , n} {d}_{i , j} {X}_{j} [ {( {\sum }_{i = 1}^{{Q}^{′}} {\sum }_{j = 1}^{L} {d}_{i , j} {X}_{j , k} )}^{2} \\ cos ( {ϕ}_{r} - {ϕ}_{i} ) - {( {\sum }_{i = 1}^{{Q}^{′}} {\sum }_{j = 1}^{L} {d}_{i , j} {X}_{j , k} sin {ϕ}_{i} )}^{2} - ( {\sum }_{i = 1}^{{Q}^{′}} {\sum }_{j = 1}^{L} {d}_{i , j} {X}_{j , k} cos {ϕ}_{i}\end{matrix}}{{( {\sum }_{i = 1}^{{Q}^{′}} {\sum }_{j = 1}^{L} {d}_{i , j} {X}_{j , k} )}^{4}}$$

Similarly, the partial derivates of the functions tan(θ_{E}[k]) and r_{E}² (equations (9)), are calculated for n ε[1, L] and k ε[0, M-1]:

$$\frac{\partial tan ( {θ}_{E} [ k ] )}{\partial {X}_{n}} = \frac{\begin{matrix}2 \cdot {\sum }_{r = 1}^{{Q}^{′}} {d}_{r , n} \cdot ( {\sum }_{j = 1}^{L} {d}_{i , j} \cdot {X}_{j , k} ) \cdot \\ ( {\sum }_{i = 1}^{{Q}^{′}} ( {( {\sum }_{j = 1}^{L} {d}_{i , j} \cdot {X}_{j , k} )}^{2} \cdot sin ( {ϕ}_{r} - {ϕ}_{i} ) ) )\end{matrix}}{{( {\sum }_{i = 1}^{{Q}^{′}} {( {\sum }_{j = 1}^{L} {d}_{i , j} \cdot {X}_{j , k} )}^{2} cos ( {ϕ}_{i} ) )}^{2}} , \\ \frac{\partial {r}_{E}^{2}}{\partial {X}_{n}} = 4 \frac{{\sum }_{r = 1}^{{Q}^{′}} {d}_{r , n} ( {\sum }_{i = 1}^{{Q}^{′}} ( {\sum }_{j = 1}^{L} {d}_{i , j} {X}_{j , k} ) ) ( {\sum }_{i = 1}^{{Q}^{′}} {( {\sum }_{j = 1}^{L} {d}_{i , j} {X}_{j , k} )}^{2} )}{{( {\sum }_{i = 1}^{{Q}^{′}} {( {\sum }_{j = 1}^{L} {d}_{i , j} {X}_{j , k} )}^{2} )}^{4}} [ ( {\sum }_{i = 1}^{{Q}^{′}} {( {\sum }_{j = 1}^{L} {d}_{i , j} {X}_{j , k} )}^{2} ) ( {\sum }_{i = 1}^{{Q}^{′}} {( {\sum }_{j = 1}^{L} {d}_{i , j} {X}_{j , k} )}^{2} cos ( {ϕ}_{r} - {ϕ}_{i} ) ) {( {\sum }_{i = 1}^{{Q}^{′}} {( {\sum }_{j = 1}^{L} {d}_{i , j} {X}_{j , k} )}^{2} sin {ϕ}_{i} )}^{2} - {( {\sum }_{i = 1}^{{Q}^{′}} {( {\sum }_{j = 1}^{L} {d}_{i , j} {X}_{j , k} )}^{2} cos {ϕ}_{i} )}^{2} ]$$

In the above paragraph relationships (8) and (9) which link the variations of the Gerzon vectors to the variations of the ambiophonic components have thus been determined. The error that the Gerzon vectors acquire is therefore a function of the error introduced on the ambiophonic components.

These relationships are used hereafter by the processing module 5 in order to determine a new type of quantification based on spatialization criteria. In one embodiment of the invention, given a data rate Deb allocated for the quantification, the processing module 5 tries to determine the quantification error h of the ambiophonic components, with the data rate Deb, which optimizes the displacement of the Gerzon vectors.

In one embodiment, the optimisation sought is the minimizing, or also the limitation below a given threshold, of the displacement of the Gerzon vectors about their position corresponding to zero error.

This amounts to searching for the value of the error vector h which allows to the Gerzon vectors to retain an orientation and a modulus fairly close to the Gerzon vectors calculated without quantification.

In fact, the Gerzon vectors make it possible to control the degree of spatial fidelity (stability and precision of the restituted sound image) during the restitution of a sound scene on a given system.

Let the vector of the following functions be considered:

$$K ( h ) = ( \begin{matrix}\vert d {θ}_{V} \vert ( h ) \\ \vert d {θ}_{E} \vert ( h ) \\ {dr}_{V}^{2} ( h ) \\ {dr}_{E}^{2} ( h )\end{matrix} ) . \qquad ( 10 )$$

This vector (10) represents the variations of the Gerzon vectors for a displacement h of the values of the ambiophonic components (Xₙ)_{1≦n≦L}.

Let Deb be the overall data rate allocated to the quantification module 6 for quantifying the ambiophonic components. The overall data rate Deb is equal to the sum of the data rates allocated to each frequency Fₛ, s=0 to M-1, of each ambiophonic component (Xₙ)_{1≦n≦L}, M representing the number of spectral bands of the ambiophonic components.

Thus Deb=Σⱼ₌₁^{L}Σ_{k=G}^{M-1}D_{j,s}.

In the case where the quantification module 6 is a high-resolution quantifier, we can write that:

$${D}_{j , k} = cte + \frac{1}{2} {log}_{10} ( \frac{{X}_{j , k}^{2}}{{{h}_{j} ( k )}^{2}} ) \qquad ( 11 )$$

Thus, in one embodiment, the optimization problem to be solved can be written as follows:

“Determine h minimizing

$$K ( h ) = ( \begin{matrix}\vert d {θ}_{V} \vert ( h ) \\ \vert d {θ}_{E} \vert ( h ) \\ {dr}_{V}^{2} ( h ) \\ {dr}_{E}^{2} ( h )\end{matrix} )$$

according to the norm ∥ ∥₂ of ⁴, in each frequency Fₖ, under the constraint of the overall data rate Deb=Σⱼ₌₁^{L}Σ_{k=G}^{M-1}D_{j,s}”.

This problem can be solved instead by considering the dual problem: “Determine h minimizing, in each frequency Fₖ, the overall data rate Deb under the constraint ∥K(h)∥₂≦∥δ∥₂”, a condition sufficient for minimizing the overall data rate Deb consisting of minimizing the elementary data rate in each frequency.

The element δ is a vector indicating a given spatial perception threshold. This threshold vector δ can be determined statistically by calculating, for different rendering systems and for different orders of ambiophonic transformation, the threshold starting from which the values taken by the ambiophonic components become perceptible.

In one embodiment, this optimization problem is solved by the processing module 5 using the Lagrangian method and gradient descent methods, for example using computer software implementing the steps of the algorithm described below. The Lagrangian and gradient descent methods are known.

During an iteration of the algorithm, each step a/, b/ or c/ is used in parallel for each frequency Fₖ, k=0 to M.

Step d/ uses the results determined for all of the frequencies Fₖ, k=0 to M-1.

Let the Lagrangian function be as follows: L(X, λ)=D_{j,k}−(K(X)−δ)^{T}.
In a first step a/, for a frequency Fₖ, the coordinates of the Lagrange vector λ are initialized: λ=λ⁽⁰⁾.

Then the steps b/ to d/ are carried out successively for (l)=(0):
In step b/, the following is determined, in relation to the frequency Fₖ,

$${h}^{( l )} / {h}^{( l )} = arg {min}_{X} \{ L ( X , {λ}^{( l )} ) \} = ( \begin{matrix}{h}_{1}^{( l )} \\ ⋮ \\ {h}_{L}^{( l )}\end{matrix} ) .$$

This determination is carried out by searching for the coordinates of X such that the partial derivatives

$$\frac{\partial L ( X , {λ}^{( l )} )}{\partial {X}_{n}} ,$$

(Xₙ)_{1≦n≦L} (λ^{(l)} fixed) are zero, using the equations (6), (7), (8) and (9).
In step c/, the following is calculated, in relation to the frequency Fₖ, λ^{(l+1)}=max {λ^{(l)}+a.g(h^{(l)},0}, where g represents the gradient function.

We have

$$g ( {h}^{( l )} ) = ( \begin{matrix}d {θ}_{V} ( {h}^{( l )} ) \\ d {θ}_{E} ( {h}^{( l )} ) \\ d {r}_{V} ( {h}^{( l )} ) \\ d {r}_{E} ( {h}^{( l )} )\end{matrix} ) .$$

The value of λ^{(l+1)} is determined using equations (6), (7) and (8) and (9).
In step d/, the data rate D_{j,k}^{(l)} allocated for the encoding of the j^{th} ambiophonic component in the frequency Fₖ, equal to

$$cte + \frac{1}{2} {log}_{10} ( \frac{{X}_{j , k}^{2}}{{{h}_{j}^{( l )} ( k )}^{2}} )$$

is determined according to equation (11). Then the sum D^{(l)}=Σⱼ₋₁^{L}Σₖ₌₀^{M-1}D_{j,k}^{(l)} of the data rates D_{j,k}^{(l)} is calculated.

The value D^{(l)} is then compared with the value Deb of the desired overall data rate.

If the value of the data rate obtained D^{(l)} is higher than the desired value Deb, (l) is incremented by 1 and steps b/ to d/ are reiterated. Otherwise, the iterations are stopped.

When in step d/ of an iteration (l_{f}), the value of the data rate D^{(l}^{^{f}}⁾ obtained is lower than the desired value Deb, the coordinates

$${h}^{( {l}_{f} )} = ( \begin{matrix}{h}_{1}^{( {l}_{f} )} \\ ⋮ \\ {h}_{L}^{( {l}_{f} )}\end{matrix} )$$

of the vector h^{(l}^{^{f}}⁾ calculated during the iteration (l_{f}) for a frequency Fₖ are those of the error minimizing the displacement of the Gerzon vectors in the frequency Fₖ.

The quantification function is thus defined for each ambiophonic component in each frequency Fₖ: the coordinate hⱼ^{(j,f)}(k) calculated for the frequency Fₖ represents the quantification error of the j^{th} ambiophonic component in the frequency Fₖ.

Once the quantification to be carried out is thus defined by the processing module 5, the module 6 determines the corresponding quantification indices for each ambiophonic spectral component and supplies this data to the module 7 for constitution of a binary sequence. The latter, after having carried out, if necessary, additional processing on the received data (for example entropic encoding), constitutes, as a function of this data, a binary sequence intended, for example, to be transmitted in a binary stream φ.

The invention thus proposes a new quantification technique applicable to multi-channel signals, which takes account of the spatial characteristics of the scene to be encoded. The quantification, defined by the allocation of the bits, by the quantification step or also by an index characterizing a quantifier from among a set, is determined in such a way as to cause a limited deviation of the Gerzon vectors and thus to guarantee an acoustic scene faithful to the original acoustic scene during the restitution of the quantified signals. The velocity and energy vectors are two mathematical tools, introduced by Gerzon, the purpose of which is to represent the localization effect, in the low and high frequency domains respectively, of a synthesized sound scene. For a listener placed at the centre of a reproduction system, the velocity vector v and the energy vector \vec{E} are associated with localization effects at low and high frequencies respectively.

In one embodiment, in practice, a transition frequency is determined which determines the fields of preponderance of the criteria \vec{V} and \vec{E}. Thus, for frequencies higher than this transition frequency, the prediction of the localization is carried out using the energy vector \vec{E} and for frequencies below this transition frequency, the localization is based on the velocity vector \vec{V}.

Physically, the transition frequency corresponds to the frequency beyond which the wave front is smaller than the size of the head. In the case of first order ambiophonic systems, this transition frequency is of the order of 700 Hz.

Starting with this data, it is then possible to split the problem of optimization into two problems. The first problem corresponds to seeking to optimize the position of the reconstructed source after quantification in the low frequency domain and the second problem corresponds to seeking to optimize it in the high frequency domain.

Thus, it is possible of reduce the number constraints to two. Therefore, only the pair

$$( \begin{matrix}\vert d {θ}_{V} \vert ( h ) \\ {dr}_{V}^{2} ( h )\end{matrix} )$$

or the pair

$$( \begin{matrix}\vert d {θ}_{E} \vert ( h ) \\ {dr}_{E}^{2} ( h )\end{matrix} ) ,$$

will be used in the optimization algorithm depending on whether operation is within the low frequency domain or in the high frequency domain.

In the embodiment described above, the invention is implemented using a spatial transformation that is the inverse of a spatial transformation used during the encoding.

In one embodiment, the Gerzon vectors are calculated and used independently of a transform optionally used during the encoding, i.e. the invention can be implemented whether or not the signals undergo a spatial or other transformation.

In fact, these Gerzon vectors are physical parameters which make it possible to characterize the reconstructed wave front by the superimposition of the waves emitted by the different loud speakers (see “Représentation de champs acoustiques, application à la transmission et à la reproduction de scènes sonores complexes dans un contexte multimédia (Representation of acoustic fields, application to the transmission and reproduction of complex sound scenes in a multimedia context)”, Doctoral thesis of University of Paris 6, 31 Jul. 2001, Jerôme Daniel).

With reference to FIG. 3 representing a restitution device 10 comprising N loud speakers Hᵢ (i=1 to N) (of which only the loud speakers H₁, Hₙ and Hₚ are shown), a listening point E in space which represents the centre of the sound restitution system 10 (FIG. 1) is considered.

It is possible in this case to calculate the velocity and energy vectors relating to this listening point E using the following formulae:

$$\begin{matrix}\vec{V} = \frac{\sum {G}_{i} {\vec{u}}_{i}}{\sum {G}_{i}} \\ \vec{E} = \frac{\sum {G}_{i}^{2} {\vec{u}}_{i}}{\sum {G}_{i}^{2}}\end{matrix}$$

where (G¹, . . . , G^{N}) are the gains of the different loud speakers Hᵢ, i=1 to N constituting the sound scene and the vectors \vec{u}ᵢ are unit vectors starting from the point E towards the loud speakers Hᵢ.

The Gerzon vectors can be calculated from this formula without the prior use of ambiophonic encoding.

In the context of producing a spatial quantifier based on Gerzon vectors, it is then possible to define the quantification problem as follows:

For a given data rate Deb, it is necessary to minimize the variation of the velocity ΔV=∥\vec{V}′−\vec{V}∥₂ and energy ΔE=∥\vec{E}′−\vec{E}∥₂ vectors, where and \vec{V}′ and \vec{E}′ represent the velocity vector and the energy vector respectively calculated after quantification. This problem is solved in a way similar to the solution described above with the use of ambiophonic transformation, based on the solution of the Lagrangian problem.

1. Method of encoding components (X_{i,k}) of an audio scene comprising N signals (S₁ . . . , S_{N}), with N>1, comprising a step of quantification of at least some of the components, characterized in that said quantification is defined as a function at least of one energy vector (\vec{E}) and/or of a velocity vector (\vec{V}) associated with Gerzon criteria and as a function of said components.

2. Method according to claim 1, according to which the quantification is defined as a function of variations of at least one of said vectors (\vec{V}, \vec{E}) during variations of components (X_{i,k}).

3. Method according to the preceding claim, according to which variations of components (X_{i,k}) corresponding to the minimization, or to the limitation, of variations of at least one of the vectors (\vec{V}, \vec{E}) are determined and quantification error values making it possible to define the quantification of the components are derived as a function of said determined variations of components.

4. Method according to one of claims 1 to 3, characterized in that it comprises a step of detection of a transition frequency making it possible to determine which one of either the energy vector or the velocity vector to take into account in order to define the quantification of components.

5. Method according to one of the preceding claims, characterized in that the components are components obtained by spatial transformation.

6. Method according to claim 5, characterized in that the spatial components are ambiophonic components, determined by an ambiophonic spatial transformation.

7. Method according to claim 5 or 6, according to which the energy vector (\vec{E}) is calculated as a function of an inverse spatial transformation (D) on said spatial components and/or the velocity vector (\vec{V}) is calculated as a function of an inverse spatial transformation (D) on said spatial components.

8. Module (5) for processing components (X_{i,k}) coming from an audio scene comprising N signals (S₁ . . . , S_{N}), with N>1, comprising means for determining elements of definition of a step of quantification of at least some of the components, as a function at least of the energy vector (\vec{E}) and/or of the velocity vector (\vec{V}) associated with Gerzon criteria and as a function of said components.

9. Audio encoder (1) suitable for encoding components (X_{i,k}) of an audio scene comprising N signals (S₁ , . . . , S_{N}) with N>1, comprising:
a module (5) for processing components according claim 8;
a quantification module suitable for defining quantification data associated with components as a function at least of elements determined by the processing module.

10. Computer software to be installed in a processing module (5), said software comprising instructions for implementing, during an execution of the software by processing means of said module, the steps of a method according to any one of claims 1 to 7.
